(19) United States
(12) Patent Application Publication
(10) Pub. No.: US 2009/0045554 A1
(43) Pub. Date: Feb. 19, 2009

(54) Vacuum-Formed Gaming Machine Top Box

(75) Inventor: Gordon H. Myers, Reno, NV (US)

Correspondence Address: BALLY GAMING INC., 6601 S. BERMUDA ROAD, LAS VEGAS, NV, 89119, US

(73) Assignee: Bally Gaming, Inc., Las Vegas, NV (US)

(21) Appl. No.: 12/259,088

(22) Filed: Oct. 27, 2008

Related U.S. Application Data
(63) Continuation of application No. 11/235,545, filed on Sep. 26, 2005, now abandoned.
(60) Provisional application No. 60/615,709, filed on Oct. 4, 2004.

(51) Int. Cl. B29C 51/00; B65D 5/50; A63F 9/24

(52) U.S. Cl. 264/549; 206/761; 463/46

(57) ABSTRACT

Disclosed herein is a top box assembly for use with gaming machines found in casinos, formed from vacuum processing, and the methods associated therewith. The vacuum-formed process for generating top box assemblies enables the efficient and economical production of visually attractive and unique top boxes including translucent spanning panels in conjunction with specially shaped front and rear panels.

### CROSS-REFERENCE TO RELATED APPLICATIONS

This application is a continuation of U.S. patent application Ser. No. 11/235,545, filed on Sep. 26, 2005, which claims priority benefit of provisional application 60/615,709 filed on Oct. 4, 2004. The above applications are explicitly incorporated by reference in their entirety for all purposes.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Field of the Invention

This invention pertains generally to gaming devices with top boxes. More particularly the invention pertains to gaming machine top boxes formed using vacuum processes and associated methods of manufacture.

2. The Prior Art

Gaming devices for use in casinos and other entertainment venues are known. The most ubiquitous type of gaming device is the slot machine. Until the late 1970s, slot machines were mechanical or electro-mechanical (i.e., mechanical reels controlled by mechanical components with solenoids, servos, etc.). Since that time, slot machines gradually used more electronics until the present, where slots are purely electronic. Purely electronic slots use video screen outputs to simulate the look and feel of traditional mechanical reel slots. This includes giving the appearance of reels on the screen sitting still before play begins, and after a wager giving the appearance of spinning reels followed by the reels slowing and stopping, finally showing a screen having the game results. Other gaming devices using electronics include video poker, video keno, video lottery, and the like.

Gaming machines use enclosures or cabinets in which the mechanical, electro-mechanical, and purely electronic components are housed. An exemplar cabinet is shown in FIG. 1. Gaming machine 100 is called a slant-top style cabinet. Other basic configurations are the upright (may or may not use a top box) and the bar top (for use on counter-tops and bars). Gaming machine 100 includes candle 102; top box 104; meters and player information displays 118 (typically an LED display); game view area(s) 108 which enable a player to view reels or video displays; front panel 110; input devices 106 for monetary, voucher, or other credit generating input; and player controls 112 (typically buttons but may include any input devices). Side view of gaming machine 100 shows the angle of the top 114 relative to the player, which gave rise to the name “slant top”. Top box 104 is rectangular, and is the same width as the rest of the gaming machine. The front of top box 104 will normally have images portraying the game theme and/or game paytables.

Other examples of prior art gaming machines include U.S. Design Pat. D451,151 which shows an upright gaming machine cabinet with no top box. U.S. Design Pat. D463,504 shows a gaming machine with a square top box. U.S. Design Pat. D458,971 shows a round-top top box on a gaming machine. U.S. Design Pat. D404,436 is another example of the prior art round-top style top box. Each exemplar design patent just discussed is incorporated herein by reference.

Construction of the round-style or square-style top boxes is the same. Each uses a solid material such as shaped particle board, shaped wood, or in some cases steel stampings. The top box construction material is opaque and usually painted black. Vents are cut into the material during manufacturing to allow for air flow through either the top box or the entire game enclosure (see, e.g., the top of the top-box in U.S. Pat. D404,436). The front of prior art top boxes is etched glass, and may be backlit. If they are backlit, venting is required.

The remaining general style of prior art top box is shown in U.S. Pat. D463,506. Instead of the round-top or square-top top box, the top of the gaming machine platform is used to hold a piece of sculpture or sometimes a sign.

There is a need for new processes for manufacturing top boxes using efficient and economical procedures, and processes which may further lend themselves to generating complex and innovative structures.

### SUMMARY OF THE INVENTION

In accordance with one embodiment of the invention, a method of constructing a gaming machine top box includes the steps of providing a front panel and a back panel, each having a perimeter and a bottom edge, each bottom edge attachable to a top-box bottom. The method further includes the steps of vacuum-forming a plurality of spanning panels, the spanning panels having no inclusions and having end contours corresponding to sections of the front panel and back panel perimeters. The method further includes the steps of attaching the front panel and back panel bottom edges to the top-box bottom, matching the end contour of each spanning panel to its respective corresponding sections of the front and rear panels and attaching each spanning panel to the front and rear panels.

In accordance with a second embodiment of the invention, a gaming machine top box assembly may be made by the process of:
a) providing a front panel and a back panel, each having a bottom edge and a perimeter, the bottom edges attachable to a top-box bottom;
b) vacuum-forming a plurality of spanning panels, the spanning panels having no inclusions and having end contours corresponding to sections of the front panel and back panel perimeters;
c) attaching the front and rear panel bottom edges to the top-box bottom; and
d) attaching each spanning panel to the front and rear panel at its respective corresponding sections.

In accordance with another embodiment of the invention, a gaming machine with top box includes a gaming machine base cabinet, having a top with a top-box attached to the top. The top-box includes a bottom, a front panel and a back panel, each panel having a perimeter and a bottom edge with the bottom edge attached to the bottom. The top-box also includes a plurality of vacuum-formed spanning panels having no inclusions attached to corresponding sections of the perimeters of the front panel and the back panel.

Other features and advantages will become apparent from the following detailed description, taken in conjunction with the accompanying drawings, which illustrate by way of example, the features of the various embodiments.

### BRIEF DESCRIPTION OF THE DRAWINGS

The present invention will be more fully understood by reference to the following drawings, which are for illustrative purposes.

FIG. 1 is an exemplar prior art gaming device with prior art top box.

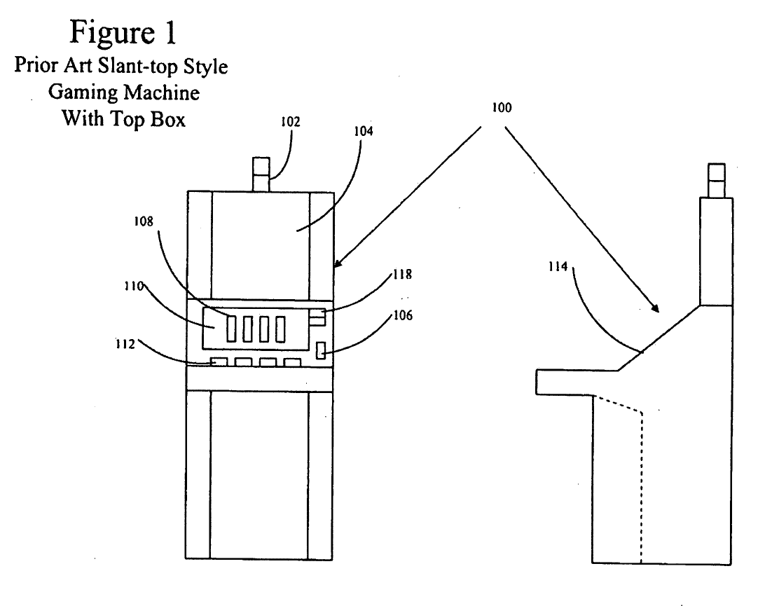

FIG. 2 illustrates a gaming device with top box in accordance with one embodiment of the present invention.

FIG. 3 is an exploded view of a top box in accordance with one embodiment of the present invention.

FIG. 4 is a flow diagram of a reduced-cost method of designing complex, interesting top box shapes in accordance with one embodiment of the present invention.

### DETAILED DESCRIPTION

Persons of ordinary skill in the art will realize that the following description of the present invention is illustrative and not in any way limiting. Other embodiments of the invention will readily suggest themselves to such skilled persons having the benefit of his disclosure.

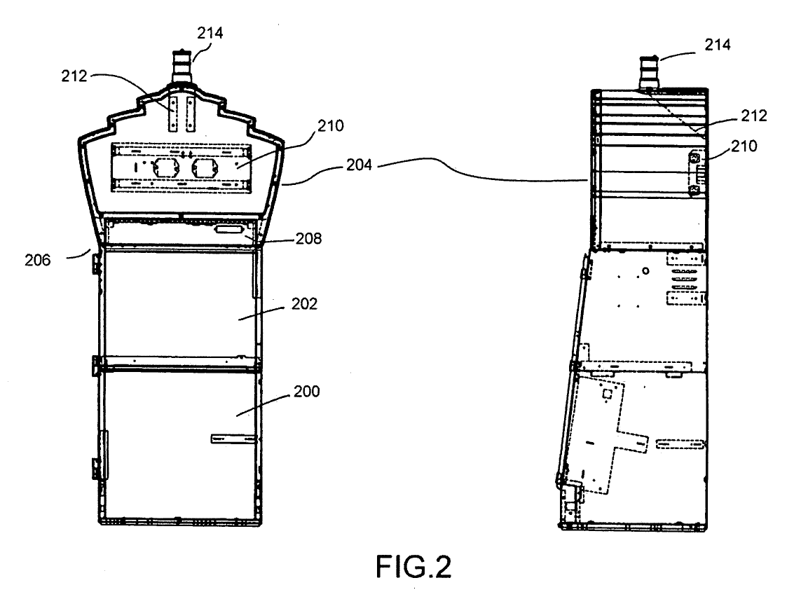

Referring more specifically to the drawings, for illustrative purposes the present invention is illustrated in FIG. 2 through FIG. 4. It will be appreciated that the apparatus may vary as to configuration and as to details of the parts, and that the method may vary as to details, order of the actions, or other variations without departing from the inventive concepts disclosed herein.

FIG. 2 shows a gaming machine cabinet with a top box in accordance with the present invention. The gaming machine is for Class II or Class III games, as defined under IGRA, 25 USC § 2701 et seq. The gaming machine cabinet has bottom area 200, which typically has large components therein such as coin hoppers, bill storage bins, ticket or voucher paper, and similar items. Upper area 202 typically encloses the electro-mechanical reels or video display and player input panels and related controls (buttons, etc.). The gaming machine's main processor board and related electronics may be in either area, depending on the design of the internals.

Top box 204 has a unique profile, enabled by the inventive concepts disclosed herein. One unique aspect of the present invention is overhang 206. Prior art top boxes were limited to being the same as or smaller than the main enclosure. The present invention allows top boxes to make use of the space found between gaming machines when they are on a casino floor (or bingo hall or any other gaming establishment), while keeping the back offset unaffected. Gaming machines are typically placed back-to-back (or against walls) when in use, but are spaced with some number of inches between cabinets side-to-side. This is to allow room for patrons' comfort. The present invention enables game designers to uses this otherwise unused space. Use of this space is not a requirement to practice the presently disclosed inventive concepts; however, it is now possible to use this previously underutilized space resource.

Game designers can maximize customer recognition utilizing the presently disclosed concepts by quickly and inexpensively making two similarly shaped top boxes. One has sides that extend outwards from the sides of the base cabinet 206, and one has sides extending straight up or in from the sides of the game cabinet, but otherwise having the same shape. Due to the inexpensive design and manufacturability of the top box disclosed herein, a game designer can economically create two top box designs for a game. Each installation can then select between the two similarly themed top box options on an as-needed basis. In the example shown in FIG. 2, the easiest way of creating the second design for this particular motif would be to make the sides vertical.

Continuing with FIG. 2, also shown is a lighting fixture and ballasts 210 used to backlight the front panel of the top box, supports 212 for top candle 214, and a surround for player panel 208 which has a players' card reading device mountable thereon.

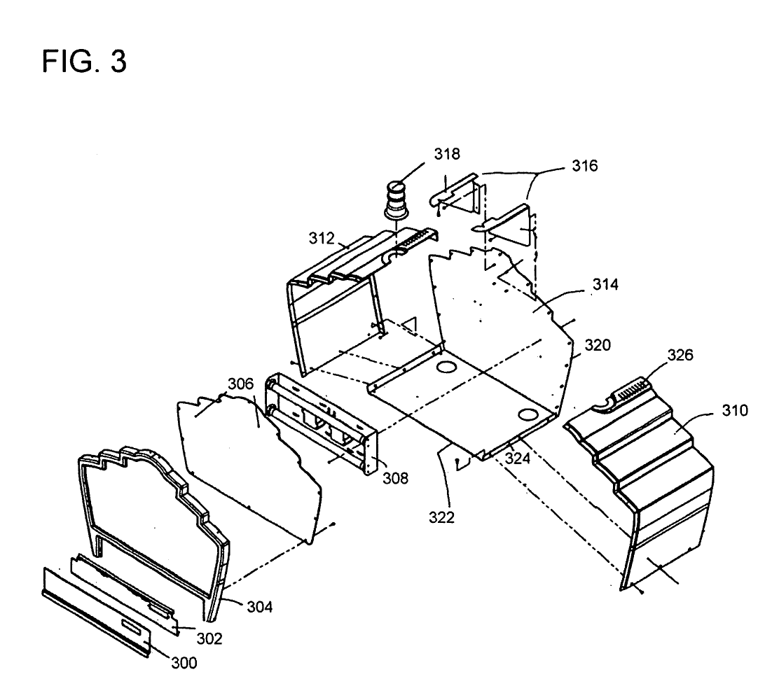

FIG. 3 shows exemplar components of a top box in accordance with the present invention. Face plate 300 and support bracket 302 are used in conjunction with bezel 304. Bezel 304 is a plastic molded strip, preferably having a pleasing external contour and coloring, and in this example having two openings or sections. One section is the lower section allowing space for card reader face plate 300 and 302. Bezel 304 is a structural member of this exemplar embodiment in addition to being visually pleasing. It is possible to mold the spanning panels to not require a bezel (fasten directly to the front panel), but use of the bezel is currently preferred. The bottom section is molded such that it surrounds border face plate 300 along its top and two vertical sides. Face plate 300 is shown with allowances for a player to insert a payer's card into a reader (reader not shown); any configuration of face plate 300 may be used. Further, bezel 304 need not have allowances for any type of plate along its bottom portion; in an alternative embodiment bezel 304 will have a single opening for front panel 306 and no lower opening. Other configurations of bezel 304 will come to the mind of a person experienced in this art and having the benefit of the present disclosure; for example, there could two lower openings next to each other for various player input devices or small LCD screens, etc.

In one preferred embodiment bezel 304 has bosses molded into its backside, which locate front panel 306 by aligning with holes cut into front panel 306 along its outer edge. Front panel 306 is fastened to bezel 304 using small screws. Although permanent fixing means such as epoxies may be used, the currently preferred embodiment uses screws to allow disassembly and replacement of components of the top box assembly, and to allow access to the internals of the top box for service from the front of the assembly. The front panel is designed to be screwed to the bezel, with the assembly then screwed into place using molded flanges in the front part of the spanning panels (310, 312). In the currently preferred embodiment, the bezel provides structural rigidity to the front of the top box assembly when combined with the acrylic sheet front panel.

A future embodiment may make use of permanent fixing means at some or all joints, resulting in the permanently joined portions being replaceable only as a unit; if all joints use a permanent fixing means, the result will be a single top box assembly replaceable only as an entire unit. It is expected that one likely place to make permanent joints is between spanning members where they meet going from the front to the back of the gaming cabinet.

One preferred embodiment of front panel 306 uses acrylic sheet to enable its exterior shape to be easily cut to match the shape of bezel 304. Front panel 306 may be opaque, but the currently preferred embodiment is to use clear or colored acrylic sheet, and then paint or otherwise overlay the surface in a translucent manner with themed images and information for the player relative to the game to which it is attached. Front panel 306 is then be backlit with light source 308 inside the top box assembly. To ease construction and minimize manufacturing costs, front panel 306 is currently a flat panel. However, future embodiments of the present invention may readily make use of contoured front panels.

Base 314 is presently made from a single sheet of steel, with back portion 320 being bent at right angles as compared to the base section 322. Back portion 320 is further cut along its upward perimeter to match molded portions 310 and 312. In one preferred embodiment, the perimeter shape of its sides and upper portion will be the same is the perimeter shape of the sides and upper portion of front panel 306, minimizing development and manufacturing costs. That is not a requirement to practice the present invention, however.

Base 314 further has mounting tabs 324 that are bent at an angle to match the incline of the lower attaching section of molded portions 310 and 312. As shown, there are drilled holes in base 314 which are used with screws to attach molded portions 310 and 312 around the applicable perimeter of base 314. Although this is the currently preferred embodiment, any attachment means is within the inventive scope of the present disclosure.

Molded spanning elements 310 and 312 are made from plastic sheet. The currently preferred embodiment is to use translucent plastic sheet in the same or complimentary colors to the theme of game. Interior light 308 will provide the visual intensity and luminescence aspect to compliment the translucent plastic. The use of a plurality of molded portions allows complex shapes without inclusions. This avoids the requirement for injection molded parts. Injection molded parts are expensive due to the labor-intensive nature of designing and manufacturing the injection molds themselves. Although the present invention does not preclude the use of injection molded parts, it enables the use of vacuum formed parts on easy-to-develop molds. The difference in cost between developing usable vacuum molds and injection molds can typically be a factor of 10 (e.g., under $3,000 for the vacuum molds for each side of the shape shown in FIG. 2, as compared to upwards of $30,000 for each mold if it were to be injection molded). Gaming machine top boxes are often relatively low volume products, which has made it very difficult to justify the high cost of developing injection molds. The present invention, by making use of vacuum formed plastic sheet, has successfully reduced the cost to the point where game designers can design and use top box shapes and colors that are unique to each game in a game manufacturers' catalog. Previously this would have been cost prohibitive.

Brackets 316 are designed as a candle stand, to which candle 318 is attached by screws or bolts. In the currently preferred embodiment, candle brackets 316 are stamped steel. This is for electrical continuity with base 314 (which is itself grounded to the gaming machine's main cabinet), so that candle 318 is properly grounded. A secondary consideration is that when moving game machines, casino personal have a habit of using the top box candle as a handle to maneuver the machines. This puts considerable stress on the candle mounts, so they need to reasonably strong or an alternative handling means needs to be provided.

Vents 326 are molded into side molded portions 310 and 312. Molding in the vents precludes the need to cut vents later, and allows considerable flexibility in vent placement and design.

Continuing with molded spanning panels 310 and 312, it will be appreciated that there may be one or more of such moldings in accordance with the present invention. It is expected that the vast majority of top boxes made in accordance with the present invention will use two, as illustrated. However, the inventive concepts disclosed herein have been used to produced a top box design that uses three spanning moldings, due to the complexity of the shape of the top box. If needed, there may be four or more as well.

Although the preferred embodiment will use translucent plastic sheets having a color complimentary to the game, the present invention may be used with one or more metal stampings for one or more of the spanning members of the top box (molded portions 310 and 312 are spanning members or spanning elements in that they span the top box from front to back, forming the sides of the finished top box thereby). It is foreseen that there will be a specific need to use stamped metal spanning members as the upper most spanning member of a top box, with two side spanning portions being molded plastic. All such variations are within the inventive scope of the present disclosure.

Another embodiment of the present invention is to extend side tabs 324 of base 314 such that the tabs form a portion of the spanning members of the top box, requiring no inclusion to mold spanning members 310 and 312. In that embodiment, spanning members 310 and 312 may be vacuum molded in a single sheet.

Base 314 may be constructed in a number of ways. It could readily be made of heavier plastic material than spanning portions 310 and 312, providing thereby the needed stiffness to the finished assembly as currently embodied in the steel base plate. In that case, the electrical components in the top box will need to have their grounding wires run back to the main cabinet.

The problem of handling the gaming machines by their top boxes and/or the candles on top of the top boxes has led to a further improvement incorporated into the top box of the present disclosure. A primary reason candles and top boxes are used during candling is to tip the machine (as a whole) onto a hand truck or fork lift. A retractable grab point or inset grab handle has been created to enable tipping of the gaming machine without using the candle or generally grabbing the edge of the top box. In one embodiment, a steel rod having a positioning clip and a steel tube guide is placed directly behind the candle (not shown). Ordinarily, players cannot see directly onto the top of a gaming machine, so the presence of a small protruding steel rod with a rubber tip would not be visible, or if it were, is not visually distracting (the rubber grab tip is preferably the same color as the translucent plastic). The bottom of the guide tube is fastened rigidly to the bottom 322 or base 314, and is preferably braced along the upper portion 320. Casino personal simply pull a lock pin to release the handle, pull the handle vertically until the next hole in the rod matches the guide pin holes, replaced the guide pin through the holes, and then can use the protruding steel rod as a handle to pull or push the gaming machine as needed, typically to tip it so that a hand truck or fork lift can be used under the cabinet's bottom.

Alternatively a recessed grab handle is mounted in the lower back 320 of base 314, so that a person at the back of the gaming machine can pull the gaming machine towards them, allowing a hand truck or fork lift to slide underneath the gaming machine from the front. With the inclusion of grab handles or grab rods, the candle mounting brackets 316 can be eliminated and the candle mounted to the candle mounts molded into the spanning elements 310 and 312 without internal supports. If the design allows it, the candle mount may be molded entirely into a single spanning element rather than two. In this case the candle will need to be grounded to the base of the top box, or through a hole and to the main cabinet's internal ground.

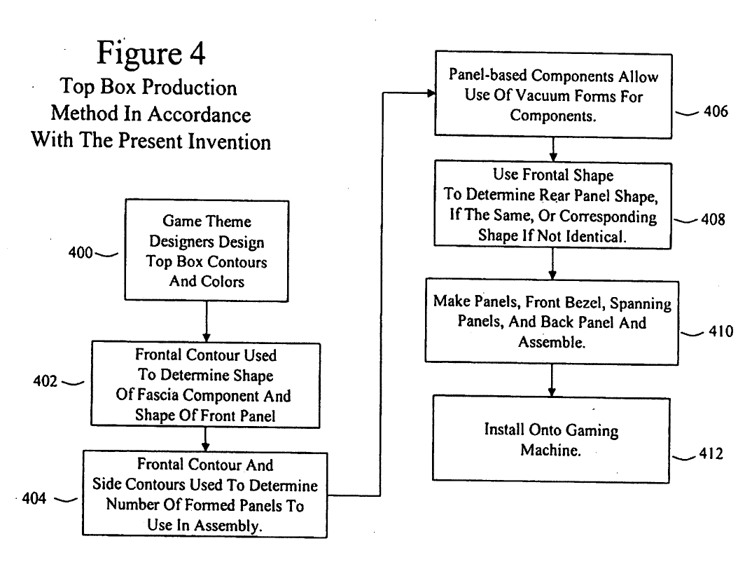

Continuing to FIG. 4, one method of using the present invention is shown in a flow chart. Box 400 represents the actions taken by the game designers or implementers to design a top box they want to use with the game being implemented in the game enclosure. They design a shape and choose one or more colors that represent the game. Since game designers are not typically manufacturing or mechanical engineers, it may be best to have the expertise available to the game designers to check that their design will work with the manufacturing and construction methods disclosed herein, or to limit the designs to those where the shape of the top box as seen from a frontal view will be the same for the back. The later constraint results in a design where the spanning members (spanning panels) will be moldable using relatively few, inexpensive vacuum molds.

Continuing to box 402, the frontal contour generating by the game designer or top box designer is used to define the contour of the front panel, and is further used to generate the entire shape of the front bezel (including mounting bosses used to position and fasten the bezel to the front panel).

Continuing into box 404, the top box design is used to determine the number of spanning panels needed and the shapes of the molds needed to produce them. It is currently expected that the vast majority of top boxes will have two spanning sheets, requiring two molds, similar to those shown in FIG. 3. Moving to box 406, the actions corresponding to this box are those needed to make the molds, preferably vacuum molds. It is expected that the vast majority of top boxes designed and made in accordance with the present invention will make use of one or two vacuum molds for each top box due to the relatively simple contours found in the individual spanning elements. Moving along into box 408, the contour of the upper and side portions of the rear panel are made in accordance with the front panel. The preferred embodiment is to make them the same. However, it is possible to have the rear panel be a different shape than the front panel, in which case the design of the spanning panels will need to conform accordingly. This increases the complexity of the spanning panel moldings, but can still be done without inclusions.

Continuing into box 410, front panel, bezel, rear panel, and spanning panels are made and assembled. Other internal components will be added as required for the application. For example, it is expected that candles will be fitted to most top boxes, in which case any internal support structures will be assembled at the same time. Further, if grab handles or other grab points are to be added, they will be assembled at the same time as the candle.

Box 412 corresponds the actions required to mount the top box to the game cabinet. No specific order is implied. For example, it may be the case that the base of the top box is installed on a game cabinet first, and then the rest of the top assembled onto the already mounted base.

A further advantage is enabling a player to identify a favorite game from a distant vantage point. Using unique shapes and colors, game designers can enable players to find the machines they want no matter where they are on the casino floor. Further, if the front panel, bezel, rear panel, and spanning panels are assembled using screws, individual parts may be replaced or the color of the translucent panels changed (by changing the spanning panels) as needed while the gaming machine is on the casino floor.

Although the description above contains certain specificity, the described embodiments should not be construed to be the scope of the disclosed invention; the descriptions provide an illustration of certain preferred embodiments. The scope is determined by the claims and their legal equivalents.

What is claimed:

1. A method of manufacturing a non-geometrically shaped gaming machine top box comprising the steps of:
providing a front panel and a back panel, each having a perimeter and a bottom edge, each bottom edge attachable to a top-box bottom, the upper portions of the respective perimeters including corresponding irregular shaping;
vacuum-forming a plurality of spanning panels, said spanning panels having no inclusions and having end contours corresponding to sections of the front panel and back panel perimeters;
attaching the front panel and back panel bottom edges to the top-box bottom;
matching the end contour of each spanning panel to its respective corresponding sections of the front panel and the rear panel; and
attaching each spanning panel to the front panel and the rear panel.

2. The method of claim 1, wherein the bottom panel and the back panel are formed from a single piece of stamped steel, and wherein the bottom edge of the back panel is formed by bending the piece of stamped steel at a 90-degree angle along the bottom edge.

3. The method of claim 1, further comprising attaching a front bezel to the front panel and the plurality of spanning panels.

4. The method of claim 1, further comprising attaching a candle one or more of the spanning panels.

5. The method of claim 1, wherein at least one of the plurality of spanning panels comprises at least one vent.

6. The method of claim 1, wherein said attaching further comprises removably attaching.

7. A process of making a gaming machine top box assembly by:
a) providing a front panel and a back panel, each having a bottom edge and a perimeter, the bottom edges attachable to a top-box bottom;
b) vacuum-forming a plurality of spanning panels, the spanning panels having no inclusions and having end contours corresponding to sections of the front panel and back panel perimeters;
c) attaching the front and rear panel bottom edges to the top-box bottom; and
d) attaching each spanning panel to the front panel and rear panel at its respective corresponding sections.

8. The product of the process of claim 7.

9. The process of claim 7, wherein the bottom and the back panel are formed from a single piece of stamped steel, and wherein the bottom edge of the back panel is formed by bending the piece of stamped steel at a 90-degree angle along the bottom edge.

10. The product of the process of claim 9.

11. The process of claim 7, further comprising attaching a candle to at least one spanning panel.

12. The product of the process of claim 11.

13. The process of claim 7, wherein at least one spanning panel further comprises at least one vent.

14. The product of the process of claim 13.

15. A gaming machine with top box comprising:
a gaming machine base cabinet, having a top;
a top-box attached to the top, the top-box comprising a bottom, a front panel and back panel, each panel having a perimeter and a bottom edge, the bottom edge attached to the bottom; and
the top-box further comprising a plurality of vacuum-formed spanning panels having no inclusions, each spanning panel attached to corresponding sections of the perimeters of the front panel and the back panel.

16. The apparatus of claim 15, wherein the bottom and the back panel are formed from a single piece of stamped steel, and wherein the bottom edge of the back panel is formed by bending the piece of stamped steel at a 90-degree angle along the bottom edge.

17. The apparatus of claim 15, further comprising a front bezel removably attached to the front panel and at least one spanning panel.

18. The apparatus of claim 15, further comprising a candle attached at a top portion of one of the plurality of spanning panels.

19. The apparatus of claim 18, wherein the candle is mounted on brackets enabled to allow the gaming machine to be moved using the candle as a handle.

20. The apparatus of claim 15, wherein at least one spanning panel comprises at least one vent.
